(19) United States
(12) Patent Application Publication
(10) Pub. No.: US 2003/0187658 A1
(43) Pub. Date: Oct. 2, 2003

(54) Method for text-to-speech service utilizing a uniform resource identifier

(76) Inventors: Jari Selin, Helsinki (FI); Pekka Pessi, Helsinki (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/108,889

(22) Filed: Mar. 29, 2002

(51) Int. Cl. G10L 21/00

(52) U.S. Cl. 704/270.1

(57) ABSTRACT

A method and system for text-to-speech (TTS) service in a network that includes forming a network address to a destination node in the network. Text is inserted into a field of the address. The address is received at the destination node. The text is converted to speech at the destination node. The speech is then sent to a node in the network.

### BACKGROUND

1. Field of the Invention

This invention relates to Internet Protocol (IP) networks, and more specifically to text-to-speech (TTS) service in IP networks.

1. Discussion of the Related Art

Generally, in Internet telephony systems the actual audio and other media processing and call signaling have been separated from each other. The functionality providing network service, like connecting calls or voice messaging, can be distributed to separate physical units, each unit possibly provided by a different vendor. When an element connecting a call decides that an announcement like “The callee is not available right now. Your call is connected to a voice mail system” should be played out, it assigns this task to a separate media server (also known as an announcement server).

When requested, a media server sends the required media—usually an audio stream—directly to the caller. A media server usually has several pre-recorded messages. Each message is a separate resource with a distinct name, Universal Resource Identifier (URI). For example, some announcement servers use SIP protocol, and each message has its own SIP URI. Other protocols can be used to obtain the messages from the media server, including HTTP and RTSP. Important thing, however, is that each message has its own name, which together with server name or address would form a URI. When designing a new service, all new messages have to be assigned a new URI, and they have to be recorded on the announcement server(s).

Sometimes, however, it is not possible to use a prerecorded message. The call service logic generates a text fragment and feeds it to a text-to-speech server, which then would send the media to the caller, just like an ordinary media server. In this case the call server running the call routing logic must be extended to support the special interface used to control the TTS server. That special interface would be responsible for feeding the text to be converted to the TTS server.

Similarly, an Interactive Voice Response (IVR) application might consist of an application server with the service logic and an announcement server. The application server would receive a response from a user in the form of Dual Tone Multi-Frequency (DTMF) digits. Based on the decisions made according the user input, the application server would ask the separate media server to play out certain messages. If a TTS server is used instead of an ordinary media server, the IVR server would require a special interface to the TTS server.

Moreover, a callee may want to reject a call attempt but answer with a voice response explaining his future availability or current activities. However, providing such a service requires adding a special TTS-control interface to the terminal. Alternatively, the callee would need means to include the text of the voice response in the rejection message. The call processing logic would then contact the TTS server.

Fully utilizing a TTS service in existing Internet voice applications requires a flexible and straightforward interface for controlling them. However, the current systems and applications require modifications to the signaling protocols, e.g., the TTS commands must be carried as payload on the SIP or RTSP protocols.

### SUMMARY

The present invention is related to a method for text-to-speech (TTS) service in a network that includes: forming a network address to a destination node in the network; inserting text into a field of the address; receiving the address at the destination node; converting the text to speech at the destination node; and sending the speech to a node in the network.

The present invention is further related to a method for text-to-speech (TTS) service in a network that includes: receiving a request containing an address from a first network node at a second network node; forming a second address to a third network node at the second network node based on the request; inserting text into a field of the second address based on the request; receiving the second address at the third network node; converting the text to speech at the third network node; and sending the speech from the third network node to the first network node.

Moreover, the present invention is also related to a system for text-to-speech (TTS) service in a network that includes a first network node and a second network node. The second network node is operatively connected to the first network node over a network. The second network node receives a request from the first network node containing text in a uniform resource indicator (URI) to be converted to speech. The second network node converts the text to speech and sends the speech to the first network node.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a block diagram of TTS conversion according to an example embodiment of the present invention;

FIG. 2 is a diagram of an IP terminal receiving an incoming call using SIP protocol according to an example embodiment of the present invention;

FIG. 3 is a diagram of SIP signaling for a TTS service according to an example embodiment of the present invention;

FIG. 4 is a diagram of SIP TTS signaling with early media according to an example embodiment of the present invention;

FIG. 5 is a diagram of a system for HTTP TTS service according to an example embodiment of the present invention;

FIG. 6 is a diagram of RTSP TTS signaling according to an example embodiment of the present invention; and

FIG. 7 is a diagram of signaling for an IVR application according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention relates to methods and systems for a text-to-speech (TTS) service that may be used in networks such that the actual text to be synthesized is carried as part of a request URI. Methods and systems according to the present invention have the advantage of application independency, ie. the application does not have to be aware of the TTS service. Text-to-speech service converts given text to natural speech. A service can be connected to a PSTN network or a IP telephony network.

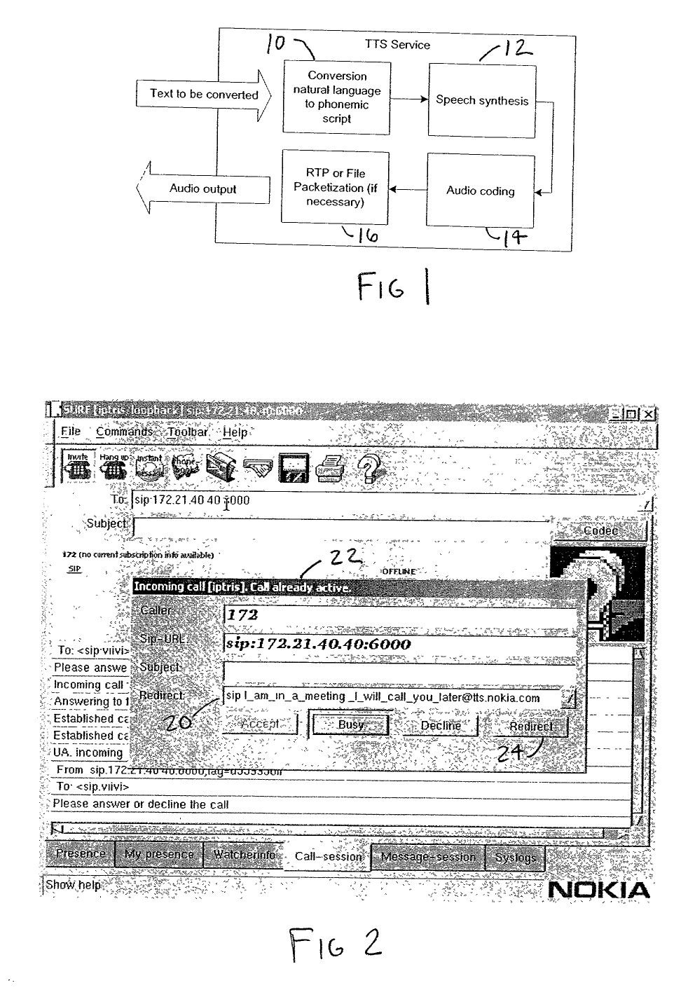

FIG. 1 shows a block diagram of TTS conversion according to an example embodiment of the present invention. A text-to-speech conversion may consists of four phases: (1) The natural text is converted into phonemic script 10, e.g., “This is a ball.” converted to [symbol] “ [symbol] is is ei ‘bo:l”; (2) the phonemic script is converted to linear audio samples 12, The audio samples can be converted to a analog signal which can be played out on local loudspeakers. However, if the audio signal is not for local consumption, but rather played out remotely, like when a TTS server is accessed through a digital communication network, the final two steps may be needed; (3) an audio codec is used to encode and compress the audio samples 14; and (4) the codec output is packetized so it can be transmitted over network or formatted so it can be stored in a file 16.

Internet telephony may use a signaling protocol known as Session Initiation Protocol (SIP). The SIP is a transport protocol that is not used to transmit the audio streams. Instead, SIP is used to set up Real Time Protocol (RTP) sessions for transmitting the audio or other media. When setting up a SIP call, the caller acts as a client, and the callee as a server. In between the caller and callee there may be a number of proxies routing the call.

SIP requests are sent from client to server with names, e.g., INVITE or ACK. SIP responses are sent from server to client and they have numbers, e.g., 100 or 302. Response codes in the range 100 . . . 199 are preliminary, they just inform a client that it's request is being processed. Response codes in the range: 200 . . . 699 are final, and they inform the client that its request has been completed; 200 . . . 299 indicate success—call has been accepted; 300 . . . 399 are used to redirect the call; and 400 . . . 699 are reserved for declining the call or different error conditions.

SIP request called INVITE is used to set up a call. It can also be used to refresh the call state (a keepalive mechanism) or modify the call, e.g., when changing the audio format used in the RTP connection. An INVITE request that is used to modify an existing call is known as re-INVITE. There are also other requests, for example, ACK is used to acknowledge reception of certain responses. BYE is used to clear a call.

Each SIP request has a destination address field known as Request-URI. The Request-URI identifies a server to which the request is sent, and a resource within the server. Usually, the resource corresponds to a user. However, there may be other kinds of resources associated with a URI.

SIP calls are routed by SIP proxies. Their routing logic takes as input the URI received in the incoming INVITE request. As output, the logic provides a list of URIs and routing action. The routing actions can include declining, redirecting, or forwarding a call. When declining, the call is dropped. When redirecting, the ultimate address of the call is returned to the previous proxy or to the caller. When forwarding, the call request is sent towards the new destination. The routing logic may be implemented as a simple script, like a SIP-CGI (Common Gateway Interface) or a CPL script.

A callee server can also initiate redirection. Instead of dropping the call (sending a 482 response code, for instance) or accepting it (sending a 200 Ok response code), the callee can ask the caller or the previous proxy to redirect the call to an another destination.

According to the present invention, when a first network node (e.g., a network server) receives a request for audio content (e.g., SIP INVITE, RTSP SETUP or HTTP GET) from a second network node (e.g., a client), it will convert the text included in the request address (URI) to the speech and deliver it to the client. The use of a request address, e.g. URI, to transport the text to be converted to speech is advantageous in that no changes are required to browsers servers or other applications.

A Uniform Resource Identifier (URI) is a compact string of characters for identifying an abstract or physical resource. A URI can be further classified as a locator, a name, or both. The term “Uniform Resource Locator” (URL) refers to the subset of URI that identify resources via a representation of their primary access mechanism (e.g., their network “location”), rather than identifying the resource by name or by some other attribute(s) of that resource. The term “Uniform Resource Name” (URN) refers to the subset of URI that are required to remain globally unique and persistent even when the resource ceases to exist or becomes unavailable.

Usually URI consists of two parts, address part and resource part. However, depending on the URI scheme, either part can be empty. The address part specifies the server that contains the resource. When using a URI, the client resolves the Internet Protocol (IP) address corresponding to the address part, and sends a request containing the resource part to the resolved IP address.

According to the present invention, embedding text to URIs may be done in several ways. Example embodiments of these will be discussed following. In any case the text should be valid according to URI syntax. For example, preferably spaces should be encoded by using an underscore “ ” of by escape sequence %20. According to the present invention, other voice parameters, like sex, pitch and speed of the speech, may be included in the request URI.

There are several options for transferring the speech for the TTS server to client. In the SIP and Real Time Streaming Protocol (RTSP) cases, normal RTP audio session may be used. In Hypertext Transfer Protocol (HTTP) audio might be transported as a complete file or the user might be redirected to a new RTSP URI.

A service request may contain preferred language(s) of the user, e.g., using Content-Language header. The preference information can be used when determining which language to use when text is converted to speech.

Some protocols that use URLs and that may be used to implement the present invention include SIP, HTTP, and RTSP. The present invention is not limited to use of these protocols, however, and covers any and all protocols that may incorporate destination addressing such as URLs and are within the spirit and scope of the present invention. To help illustrate the present invention, example embodiments using SIP, HTTP, and RTSP will be used. Examples of schemes employing these are shown following.

An example SIP URI scheme according to the present invention includes:

sip:Text_to_be_played_to_the_caller.@tts.nokia.com

In the SIP URI scheme the user part of the URI may be used to transport the text. The user part is between the “sip:” prefix and the “@” sign.

Example HTTP URI schemes according to the present invention includes:

http://tts.nokia.com/tts-cgi/?Text_to_be played_to_the_caller

http://tts.nokia.com/Text_to_be_played_to_the_caller

In the HTTP URI scheme the ‘query’ (after“?”) or path (after “/”) part of the URI is used.

An example RTSP URI scheme according to the present invention includes:

rtsp://tts. nokia.com/tts/Text_to_be_played_to_the_caller.

In the RTSP URI scheme the path part is utilized.

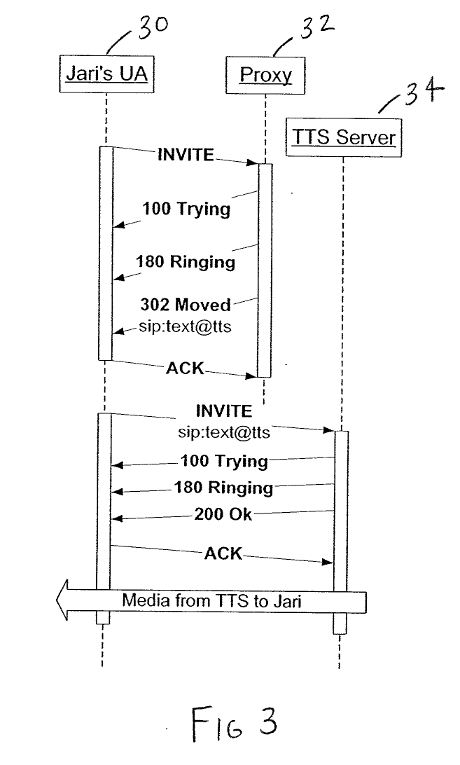

FIG. 2 shows a diagram of an IP terminal receiving an incoming call using SIP protocol according to an example embodiment of the present invention. SIP is commonly used in voice over IP applications and in future 3G networks and terminals. SIP has many call control features built in it such as call forwarding. The IP telephony terminal is receiving an incoming call. At this point the called user or device has several options: accept the call; indicate that he is busy; decline the call; or redirect the call to other destination, e.g., voicemail server.

The redirect option may be used to redirect the call to a TTS server. The SIP URL to which the call may be redirected is shown in the “Redirect” box 20 in the “Incoming call” window 22. In this example embodiment, the user has already typed some text (“I am in a meeting. I will call you later”) to the user part of the URL. After the user presses the ‘redirect’ button 24, the caller would be connected to the TTS server with address tts.nokia.com. The TTS server may then read the text in the user part of the URL to the caller.

In this example embodiment of the present invention, modifications to neither client applications nor networks elements are needed. The only requirement is the TTS server itself, which takes the user part from the incoming SIP INVITE and reads (or plays or sends) it out.

If a TTS service is an integral part of say a 3G phone, the user interface show in FIG. 2 may be enhancement by adding: one extra button, e.g., ‘TTS’, which asks the user for a text to played and then may format the URL correctly using a preset TTS server name. This addition does not require any changes in the underlying protocols, merely in the user-interface.

The user may preset his settings in the TTS server by a simple web user-interface. In the redirect case, in the incoming INVITE to the TTS sever may include the callee in the “To” field. Using the “To” field users setting can be found. According to the present invention, the settings may include such things regarding the output voice as sex of the speaker, pitch, and speed.

Redirecting may be initiated not only by clients but by servers as well. For example, a user may add a TTS SIP URL to his presence bindings. If the user cannot be reached by other means, the last option may be to forward the call to the TTS server. The TTS server may then play out the text the user has preset. This functionality does not require any changes in any of the network or client components.

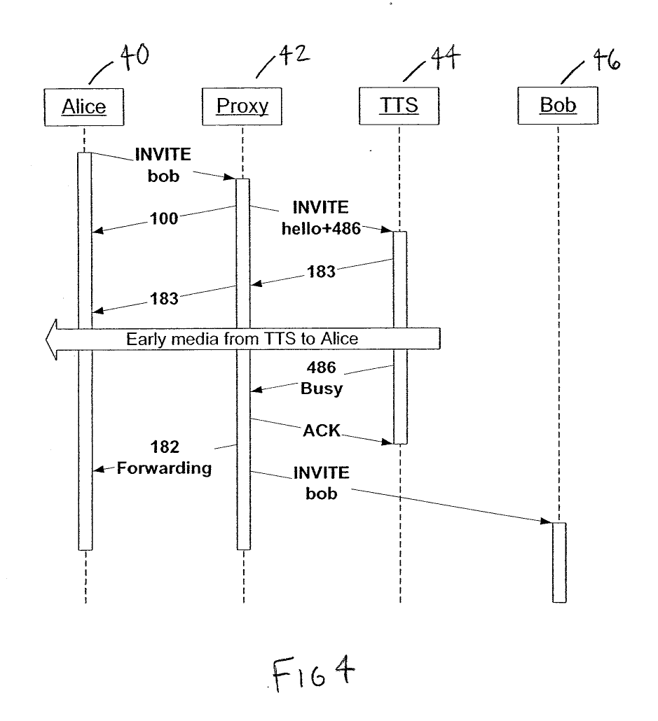

FIG. 3 shows a diagram of SIP signaling for a TTS service according to an example embodiment of the present invention. A first network node 30 (e.g., caller) sends an INVITE request message to a second network node 32 (e.g., proxy server, callee). The INVITE message is sent to callee's address. The message itself may contain the address as a Request-URI parameter.

The callee's phone responds with a “100 Trying” request message indicating to the caller's phone that the callee has received the INVITE response message and that the callee is processing the request.

The callee's phone starts alerting the caller and sends “180 Ringing” response message to the caller. Upon receiving the 180 Ringing message, the caller's phone may indicate to the caller that the call has been connected and it is alerting.

The callee may be in a meeting and may decide not to accept the call. The callee decides to give a message explaining the situation to the caller, and redirects the call to a TTS URI the callee has typed. The callee's phone 32 may send a “302 Moved” response message to the caller 30. The 302 Moved response message concludes the first call attempt.

The caller's phone acknowledges receiving the 302 response message by sending an ACK to the original callee. The caller's phone may attempt again to call to the address received in the 302 response message by sending another INVITE request, this time to a TTS server 34. The TTS URI may now be included as the Request-URI parameter.

The TTS Server 34 may accept the call attempt and answer with “200 Ok” response message to the caller. The caller's phone 30 may acknowledge receiving the 200 Ok by sending an ACK to the TTS server 34.

A RTP stream from the TTS server to the caller is established. The TTS server 34 converts the text to speech and sends the converted speech, using the RTP connection, to the caller's phone 30.

To help further illustrate the present invention, the following SIP early media hypothetical example is provided. This example represents a situation where text may be converted to speech and sent to a caller before an tempt is mad to complete the call to the callee. A person, Bob <sip:bob@brown.com>, is traveling in Australia. Bob wants to have a service where an announcement is read to everyone calling him before connecting the call to his mobile phone. The announcement should contain the current time in Australia.

Bob has a home proxy with a SIP-CGI interface. Bob's SIP home proxy may be a network element that processes all call attempts to Bob. The SIP-CGI script may be a simple program that can forward a SIP call attempt to a certain URL, and also process incoming responses, therefore, making further routing decisions. As input, the SIP-CGI script may take a current call state and incoming message (request or response). The SIP-CGI script may provide as output the new call state, and optionally a list of addresses to which the call should be forwarded or redirected.

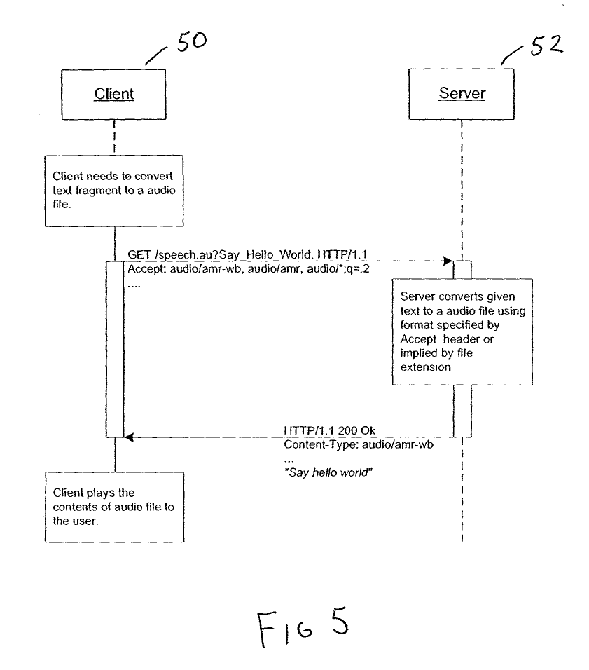

FIG. 4 shows a diagram of SIP TTS signaling with early media according to an example embodiment of the present invention. Using a SIP-TTS server Bob's service may be implemented as shown in FIG. 4. A caller's device 40 may send an INVITE message (call) to a proxy 42. After the INVITE message is received by the proxy 42, the proxy 42 may activate Bob's CGI script. The CGI script may generate an URL containing current time in Australia. The CGI script may also ask the proxy 42 to redirect the call to the TTS server using the generated URL. An example URL may look like this:

sip:=RC=183=Hello._This_is_Bob._I'm_in_Australia. The_time_is_four _a_m_here._=VOICE=FEMALE=Your_call_will_be_forwarded_to_Bob_in_a_moment=RC=486=@tts.brown.com.

The example URL above may contain some control constructs not converted to speech:

=RC=183=instructs the TTS server 44 to use SIP response 183, which also means that TTS server 44 may send the voice message as early media to the calling phone 40. Early media is unidirectional audio connection from callee to caller, usually containing the ringing tone or some announcements to the caller.

=VOICE=FEMALE=instructs the TTS server 44 to change the sex of the speaker from male to female

=RC=486=instructs the TTS server 44 to send 486 response code to the proxy 42 and drop the call. The proxy 42 may send a “100 Trying” message to the caller, and may forward the INVITE message with new Request-URI shown above to the TTS server 44.

The TTS server 44 may respond with “183 Alerting” to the call. The 183 Alerting is a SIP response code meaning that a unidirectional early media connection from the callee (the TTS server 44) to the caller (the phone device 40) has been established.

The TTS server 44 starts sending the converted speech as early media. After the TTS server 44 completes converting the URL to speech, it disconnects the call attempt by sending the “486 Busy Here” message to the proxy 42. When the proxy 42 receives the 486 response, it may activate again the CGI script. The CGI script forwards the call to Bob's mobile phone 46. If the caller did not have an urgent matter, the caller may elect to disconnect the call after hearing the message.

Embodiments of the present invention may also be implemented using HTTP. In one example embodiment, a HTTP URL may be embedded in a web page. For example, if the URL:

http://tts.nokia.com?Text_to_be_played_to_the_caller is imbedded in a web page, by clicking this URL an audio file may be fetched containing the converted text. A browser may then play the audio file. The file format may be negotiated using Multipurpose Internet Mail Extensions (MIME) headers Accept and Accept-Encoding. It may also be possible to include the audio file format in the URL itself. In this example embodiment, the user must select a suitable file format presented by an URL.

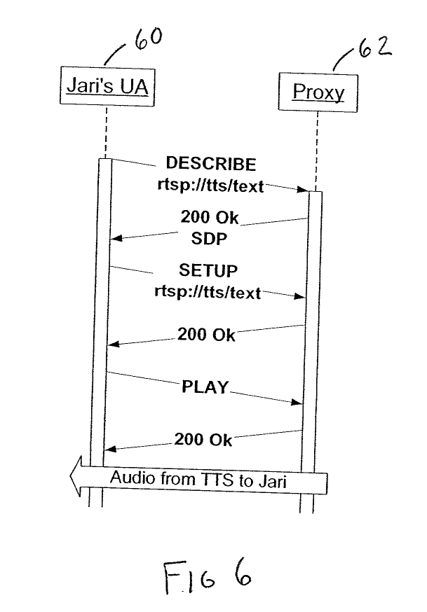

FIG. 5 shows a diagram of a system for HTTP TTS service according to an example embodiment of the present invention. A client network node 50 may have a text fragment that needs to be converted to an audio file. The text fragment may be in the form of a URL on a web page at the client node 50. The user may click on the URL causing a message containing the text to be sent to a TTS server 52. The message may also include a desired or required format for the audio file created from the text. The server 52 converts the text to an audio file. The resulting audio file may be sent as a payload of the HTTP response, instead of setting up a separate RTP stream for carrying the audio data, to the client 50. The audio file may then be played at the client node.

Embodiments of the present invention may also be implemented using RTSP. In one example embodiment, a RSTP URL may be embedded in a web page. For example, if the URL:

rtsp://tts.nokia.com/tts/Text_to_be_played_to_the_caller is embedded in a web page, by clicking the URL the user's default streaming client (e.g., Real Player, MS Media Player) may be invoked with clicked URL as an argument. This player may then contact the RTSP server specified in the above URL in order to start streaming the audio content. In this example, the TTS server may act as a RTSP server.

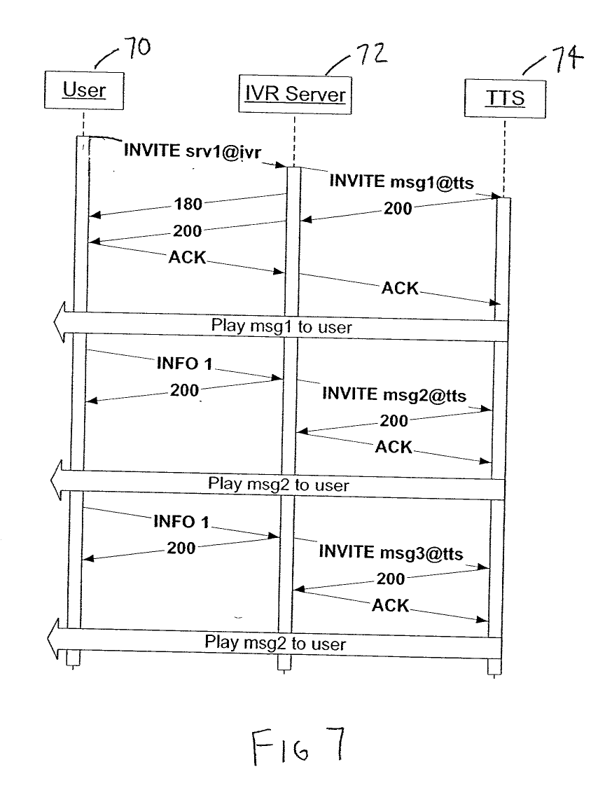

FIG. 6 shows a diagram of RTSP TTS signaling according to an example embodiment of the present invention. In this example embodiment of the present invention, the signaling between a client node 60 and a proxy node 62, that is a RTSP server, is shown. Again, this embodiment of the present invention does not require any changes in a user's applications. The web server, the web browser and the streaming client (i.e., RTSP player) may run unmodified. A web application writer may only have to modify the URL contents on the web page.

User software at the client node 60 may send a DESCRIBE request to a server 62. The server 62 may respond with a “200 Ok” response containing a Session Description Protocol (SDP) session description, that specifies the kind of audio format used in the RTP session. A SETUP message may be used to establish a session on the RTSP server 62, including initialization of a RTP connection. Upon receiving the PLAY request, the server 62 may respond with a 200 Ok message, and start sending the audio data through the RTP connection. The URL and the web page may be static, or the web application may generate the contents of the URL dynamically at the server when the page is served.

The present invention may also be implemented in embodiments that use RTSP and SIP together. For example, an interactive voice response (IVR) application may use a stimulus-response model, where a user is given stimulus with generated speech and the user can respond using Dual Tone Multi-Frequency (DTMF) tones. SIP provides means for transmitting DTMF digits with INFO requests. The application server may request a media server to play out certain voice messages with re-INVITE messages, each containing the text for the new voice prompt in the Request-URI.

FIG. 7 shows a diagram of signaling for an IVR application according to an example embodiment of the present invention. The signaling between a user node 70, IVR server 72 and TTS server 74 is shown. A User 70 calls application server 72 and sends an INVITE to the IVR server 72. The IVR application server 72 may initialize the service specified in the URL of the incoming INVITE from the user 70. The service logic at the IVR server 72 may be started. The service logic may need to establish a speech session between user and the TTS server and, therefore the server logic may INVITE the TTS server 74 to a session with user terminal 70. The text for an initial voice prompt message may be included in the Request-URI.

The TTS server 74 may accept the call and responds with a 200 Ok message. The IVR application server 72 may then forward the 200 Ok from the TTS server 74 towards the user node 70. The TTS server 74 receives ACK from the user terminal 70, and starts playing out the prompt text converted to speech.

The User has heard the message, and responds by pressing a key “1”. An INFO request may be sent with key code “1” as payload. Upon receiving the INFO request, the application server 72 may ask the announcement server 74 to play the next message. The application server 72 may send a re-INVITE request with URI identifying the next message (msg2) to the TTS server 74. Upon receiving the re-INVITE, the TTS server 74 may interrupt the previous voice message, if it is not complete, and start playing out the next one specified in the new Request-URI.

In other embodiments implementing the present invention, text may be carried as signaling payload, not embedded in the URI. This may require that the application is aware of the service. Moreover, text may be carried in an extension header. The following example SIP URL schema shows a way to include an extension header in the SIP URI:

sip:tts.nokia.com?X-TTS-Header=Text_to_be_played_to_the_caller

In addition the present invention may be implemented using some special signaling protocol, but this again may require that the application is aware of the service and has implemented this particular signaling protocol.

Embodiments employing the present invention are advantageous in that a service creator can include text that the creator wants to convert to speech in any hypertext document or link. However, no changes in browsers, servers, or other applications are required.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A method for text-to-speech (TTS) service in a network comprising:
forming a network address to a destination node in the network;
inserting text into a field of the address;
receiving the address at the destination node;
converting the text to speech at the destination node; and
sending the speech to a node in the network.

2. The method according to claim 1, further comprising inserting an identifier of a well-known text fragment into the field of the address, and converting the text fragment to speech at the destination node.

3. The method according to claim 1, further comprising forming a network address comprising a uniform resource locator (URL) to a destination node and inserting the text into a field of the URL.

4. The method according to claim 1, further comprising forming a network address comprising a communications address to a destination node and inserting the text into a field of the communications address.

5. The method according to claim 1, further comprising forming a network address comprising a hyperlink address to a destination node and inserting the text into a field of the hyperlink address.

6. The method according to claim 1, further comprising forming a network address comprising a uniform resource indicator (URI) to a destination node and inserting the text into a field of the URI.

7. The method according to claim 6, further comprising inserting the text into a field of a Session Initiation Protocol (SIP) URI.

8. The method according to claim 7, further comprising sending the speech in a normal Real Time Protocol (RTP) audio session to the node in the network.

9. The method according to claim 6, further comprising inserting the text into a field of a File Transfer Protocol (FTP) URI.

10. The method according to claim 6, further comprising inserting the text into a field of a Hypertext Transfer Protocol (HTTP) URI.

11. The method according to claim 10, further comprising sending the speech as an audio file to the node in the network.

12. The method according to claim 6, further comprising inserting the text into a field of a Real Time Streaming Protocol (RTSP) URI.

13. The method according to claim 12, further comprising sending the speech in a normal Real Time Protocol (RTP) audio session to the node in the network.

14. The method according to claim 1, further comprising including information regarding at least one of sex, pitch, and speed of the speech in the address.

15. The method according to claim 1, further comprising including information regarding a preferred language of the speech in the address.

16. The method according to claim 1, further comprising converting the text to a phonetic representation of the speech at the destination node and sending the phonetic representation of the speech to the node in the network.

17. A method for text-to-speech (TTS) service in a network comprising:
receiving a request containing an address from a first network node at a second network node;
forming a second address to a third network node at the second network node based on the request;
inserting text into a field of the second address based on the request;
receiving the second address at the third network node;
converting the text to speech at the third network node; and
sending the speech from the third network node to the first network node.

18. The method according to claim 17, further comprising inserting an identifier of a well-known text fragment into the field of the second address, and converting the text fragment to speech at the third network node.

19. The method according to claim 17, further comprising forming a second network address comprising a communications address to a third node and inserting the text into a field of the communications address.

20. The method according to claim 17, further comprising forming a second network address comprising a hyperlink address to a third network node and inserting the text into a field of the hyperlink address.

21. The method according to claim 17, further comprising forming a second network address comprising a Uniform Resource Indicator (URI) to a third network node and inserting the text into a field of the URI.

22. The method according to claim 21, further comprising inserting the text into a field of a Session Initiation Protocol (SIP) URI.

23. The method according to claim 22, further comprising sending the speech in a normal Real Time Protocol (RTP) audio session to the first network node.

24. The method according to claim 21, further comprising inserting the text into a field of a File Transfer Protocol (FTP) URI.

25. The method according to claim 21, further comprising inserting the text into a field of a Hypertext Transfer Protocol (HTTP) URI.

26. The method according to claim 25, further comprising sending the speech as an audio file to the first network node.

27. The method according to claim 21, further comprising inserting the text into a field of a Real Time Streaming Protocol (RTSP) URI.

28. The method according to claim 27, further comprising sending the speech in a normal Real Time Protocol (RTP) audio session to the first network node.

29. The method according to claim 17, further comprising storing the text to be converted to speech at the second network node.

30. The method according to claim 29, further comprising storing the text to be converted to speech at the second network node before the receiving of the request.

31. The method according to claim 17, further comprising generating the text to be inserted based on information contained in the request.

32. The method according to claim 17, further comprising generating the text to be inserted based on service type information contained in the request.

33. The method according to claim 17, further comprising generating the text to be inserted based on requester address information contained in the request.

34. The method according to claim 17, further comprising generating the text to be inserted based on one of the second network node as the original request destination and the third network node as the current request destination.

35. The method according to claim 17, further comprising generating the text to be inserted based on one of time of day and request priority information contained in the request.

36. A system for text-to-speech (TTS) service in a network comprising:
a first network node; and
a second network node, the second network node operatively connected to the first network node over a network, the second network node receiving a request from the first network node containing text in a uniform resource indicator (URI) to be converted to speech,
wherein the second network node converts the text to speech and sends the speech to the first network node.

37. The system according to claim 36, wherein the text is contained in a field of a Session Initiation Protocol (SIP) URI.

38. The system according to claim 37, wherein the speech is sent in a normal Real Time Protocol (RTP) audio session to the first node in the network.

39. The system according to claim 36, wherein the text is contained in a field of a File Transfer Protocol (FTP) URI.

40. The system according to claim 36, wherein the text is contained in a field of a Hypertext Transfer Protocol (HTTP) URI.

41. The system according to claim 40, wherein the speech is sent as an audio file to the node in the network.

42. The system according to claim 36, wherein the text is contained in a field of a Real Time Streaming Protocol (RTSP) URI.

43. The system according to claim 42, wherein the speech is sent in a normal Real Time Protocol (RTP) audio session to the node in the network.

44. The system according to claim 36, further comprising a third network node, the second network node forwarding the URI to the third network node, the third network node converting the text to speech and sending the speech to the first network node.
